(19) United States
(12) Patent Application Publication
(10) Pub. No.: US 2007/0254206 A1
(43) Pub. Date: Nov. 1, 2007

(54) Methods for production of metals on carbon nitride powders and composites and their use as catalysts in fuel cell electrochemistry

(76) Inventors: Edward G. Gillan, Iowa City, IA (US); Dale R. Miller, Derwood, MO (US); Drew C. Dunwoody, N. St. Paul, MN (US); Johna Leddy, Iowa City, IA (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/654,768

(22) Filed: Jan. 17, 2007

Related U.S. Application Data
(60) Provisional application No. 60/759,313, filed on Jan. 17, 2006.

(51) Int. Cl. H01M 4/00

(52) U.S. Cl. 429/40; 429/12; 502/174

(57) ABSTRACT

Improved supported catalyst compositions including metalated carbon nitrides and methods of preparation are disclosed.

### CROSS REFERENCE TO RELATED APPLICATION

This application claims priority to copending U.S. Provisional Application No. 60/759,313 to Gillan et al., filed on Jan. 17, 2006, and entitled “Methods for Production of Metals on Carbon Nitride Powders and Composites and Their Use as Catalysts in Fuel Cell Electrochemistry,” the disclosure of which is incorporated herein by reference in its entirety.

### STATEMENT OF FEDERALLY SPONSORED RESEARCH

This invention was made with government support under grant No. DAAD19-03-1-0274 awarded by the U.S. Army Research Office. The United States government has certain rights in the invention.

### FIELD OF THE INVENTION

This invention relates to chemical compound composites such as carbon nitride powder coated with metals. These compounds have applications in a number of applications such as heterogeneous catalysis in hydrogenation reactions and in fuel cells.

### BACKGROUND OF THE INVENTION

In general, stable supported heterogeneous catalysts are useful across the chemical industry (e.g., in hydrogenation reactions). Such catalysts may also be highly useful in production of economically viable fuel cells.

Supported catalysts used in fuel cells, such as proton exchange membrane (PEM) fuel cells, typically consist of noble metal nanoparticles tethered to an electronically conducting support such as carbon black (e.g., VULCAN® XC-72, available from Cabot Corporation of Boston, Mass.). Platinum on carbon black is a commonly used material used in fuel cell catalysts.

Four major advantages accrue from the structure of these materials: lower precious metal loading to reduce cost; highly dispersed metal to yield a high surface area catalyst; tethered metals to enhance catalyst stability; and sufficient electronic conductivity to sustain effective electrocatalysis. The principal disadvantages of these supported catalysts are instability and the costs associated with dispersion and precious metals. In operational fuel cells, metal catalyst particles tend to redistribute from their original small size to larger, lower surface area catalysts by Ostwald ripening during its electroactive fuel cell lifetime. The ripening, which is often apparent after only a few days of operation, frequently deposits catalyst out of electrical contact with the support. This metal migration is a significant contributor to the death of the catalyst and loss of function in the fuel cell.

Improving catalyst activity and lifetime in fuel cells is a critical issue that must be solved before these systems will be useful as commercial alternative energy sources. Significant increases in the operational lifetime of a fuel cell catalyst electrode will lower the overall cost of fuel cell power generation. Thus, supported catalysts with lower cost and better stability are needed to advance fuel cell technologies.

### SUMMARY OF THE INVENTION

The thermal, chemical, and electrochemical properties of novel nitrogen-rich carbon nitride (C₃N₄₊ₓ) network materials were examined for use in the catalyst layer of proton exchange membrane (PEM) fuel cell electrodes. These lone pair rich solid networks can modify the local coordination environment around individual metal catalyst sites, influencing catalytic efficiency and stability. As a component of fuel cell electrodes, the nitrogen sites in C₃N₄₊ₓ may coordinate and modify the local electronic and chemical bonding environment of metal catalyst particles to a greater degree than conventional carbon support materials.

Carbon nitride powders coated with catalytically active metals, such as platinum, were produced and showed improved resistance to corrosive solution environments relative to commercially available platinum on carbon catalysts. The carbon nitride provides extended support for metal catalysts. Platinum (Pt) and other metals can be deposited on synthesized carbon nitride powders. These Pt on carbon nitride materials do not leach platinum into strongly acidic NAFION® (DuPont) perfluorosulfonic acid polymer solutions, and composite electrodes with these metalated carbon nitrides function as active catalysts in a working fuel cell assembly.

The present invention improves metal catalyst stability by binding it to a carbon nitride support material. This metal/support combination functions as a catalyst in fuel cells. Further, the invention provides a stronger platinum catalyst support interaction than is found in current commercial materials, which should lead to enhanced operational lifetimes for fuel cell assemblies. The unique metal binding ability of the carbon nitride may also lead to increased catalytic stability and activity from less expensive non-platinum metals.

The invention is a chemical compound composite (carbon nitride powder coated with metal), with and without carbon black additives, that has advantages over conventional catalyst material for use in a fuel cell environment.

Fuel cell tests show power outputs at about ⅓ that from a cell using commercial catalysts. The full working fuel cell tests with 40 wt % platinum on carbon nitride (diluted 50:50 with carbon black for an effective 20% Pt loading) were conducted to show that these materials function in PEM fuel cell assemblies.

In one embodiment, the invention is directed toward a supported catalyst including metalated carbon nitride. The metal may be platinum, nickel, silver, cobalt, vanadium, ruthenium, iron, manganese, or copper and may be a combination of two or more of these metal such as cobalt and iron or platinum and ruthenium. At least a portion of the carbon nitride is bonded to carbon cloth. The supported catalyst may also include carbon black. The carbon black may be present in an amount that is 25% to 75% by weight of the catalyst. The carbon black is VULCAN® XC-72 carbon black.

In another embodiment, the invention is directed toward a method for producing a supported catalyst wherein carbon nitride is metalated. The metal may be selected from the group consisting of platinum, nickel, silver, cobalt, vanadium, ruthenium, iron, manganese, and copper and may be a combination of two or more of these metal such as cobalt and iron or platinum and ruthenium. The metalating of the carbon nitride may be carried out in the presence of methanol. The carbon nitride may be treated with a strong organic base prior to metalating the carbon nitride such as pyridine. One or more functional groups on the carbon nitride may be modified prior to metalating, such as by reaction with an organochloride.

In another embodiment, the invention is directed toward a fuel cell comprising a metalated carbon nitride catalyst. The carbon nitride catalyst may be located on at least one electrode and that electrode may be coated with a perfluorosulfonic acid polymer.

### BRIEF DESCRIPTION OF THE DRAWINGS

FIG. 1 is representation of prototypical molecular structures of phthalocyanine, porphyrin, polypyrrole and proposed molecular structure for carbon nitride networks with a triazine structure.

FIG. 2 represents potential current and power curves for pyridine washed carbon nitride with Pt deposited post-synthesis of the carbon nitride. Conditions are 200 sccm of H₂/300 sccm O₂ (▪) and 200 sccm of H₂/300 sccm air (∘) in a 70° C. cell. The carbon nitride electrode is on the anode with 0.38 mg/cm² of Pt; the cathode is ALFA AESAR® HISPEC™ 3000 (20 wt % Pt on carbon) with 0.41 mg/cm² of Pt.

FIG. 3 is a SEM comparison of particle morphologies of ground pure carbon nitride materials (left) and in-situ composites formed between carbon nitrides and carbon black (right).

FIG. 4 is a comparison of electroactivity of pure C₃N₄₊ₓ (2DM95a) versus pure NAFION® films in 0.1 M Na₂SO₄ solution. Note that the bare electrode trace is offset by 2 μA for clarity.

FIG. 5 is a comparison of cyclic voltammetry of a redox active component [Ru(bpy)₃²⁺] using various modified carbon electrodes in 0.1 M HNO₃.

FIG. 6 is a comparison of slopes of peak current versus v^{1/2} for carbon disk electrode with NAFION® coatings containing carbon black (white), carbon nitride (red), or in-situ carbon nitride/carbon black composite material (blue).

FIG. 7 is a cyclic voltammetry comparison in N₂ purged 0.10 M Na₂SO₄ of carbon paste electrodes containing 50:50 weight % carbon black mixtures with (A, D) Pt/C₃N₄₊ₓ (pyridine pretreated samples), (B) commercial Pt on carbon black, or (C) a Pt disk electrode. The CV scans are offset for clarity.

FIG. 8 is a cyclic voltammetry comparison in O₂ purged 0.10 M Na₂SO₄ of carbon paste electrodes containing 50:50 weight % carbon black mixtures with (A) Pt/C₃N₄₊ₓ (pyridine pretreated sample), (B) commercial Pt on carbon black, or (C) a Pt disk electrode. The CV scans are offset for clarity.

FIG. 9 is a cyclic voltammetry comparison in CO purged 0.10 M Na₂SO₄ of carbon paste electrodes containing 50:50 weight % carbon black mixtures with (A) Pt/C₃N₄₊ₓ (pyridine pretreated sample), (B) commercial Pt on carbon black, or (C) a Pt disk electrode. The CV scans are offset for clarity.

FIG. 10 is a cyclic voltammetry comparison in a N₂ purged solution of 0.10 M Na₂SO₄ and 0.20 M MeOH of carbon paste electrodes containing 50:50 weight % carbon black mixtures with (A) Pt/C₃N₄₊ₓ (pyridine pretreated sample), (B) commercial Pt on carbon black, or (C) a Pt disk electrode. The CV scans are offset for clarity.

FIG. 11 is the main Inventory of Electrode Materials.

FIG. 12 is a comparison of Oxygen (O₂) CV data.

FIG. 13 is a comparison of CO CV data.

FIG. 14 is a comparison of Methanol CV data.

### DETAILED DESCRIPTION

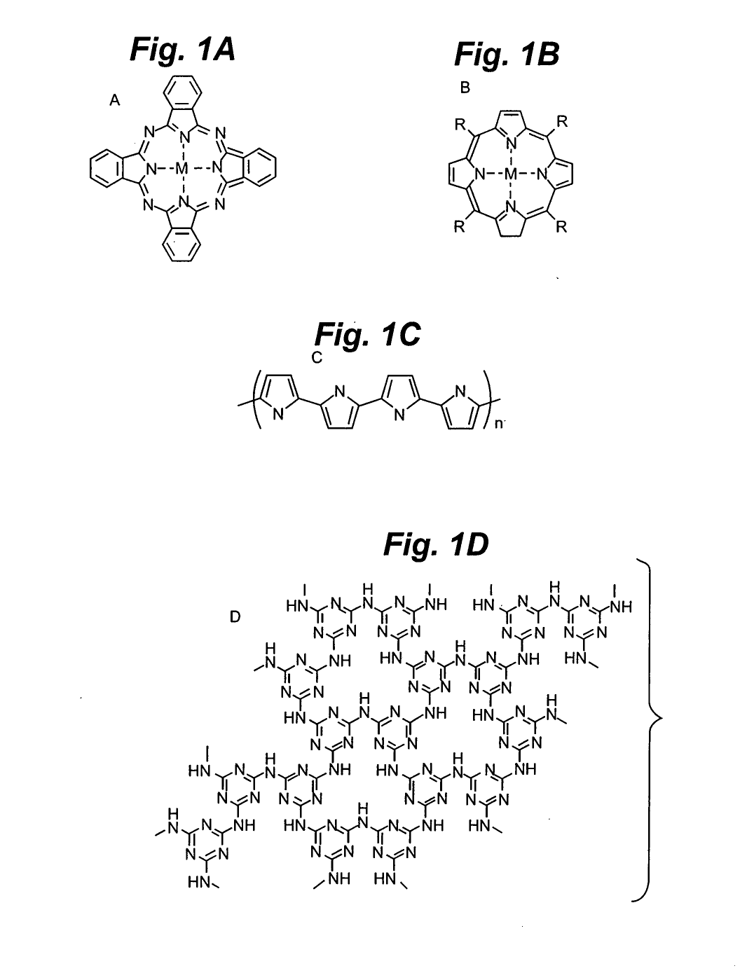

Three-dimensional carbon nitrides have structural analogy to two-dimensional metal porphyrin, phthalocyanine, and three dimensional cobalt-polypyrrole catalysts for fuel cell relevant electrochemical transformations (FIG. 1). Prototypical phthalocyanine is shown at (A), porphyrin is shown at (B), polypyrrole is shown at (C), and a proposed ordered structure for carbon nitride networks with a triazine (C₃N₃) structure C₃N_{4.5}H_{1.5} is shown at (D).

Metalation of the carbon nitride materials with metals such as platinum, nickel, silver, cobalt, vanadium, ruthenium, iron, manganese, and copper yields an effective electrocatalyst. The material is remarkably stable in NAFION® suspension, unlike existing commercial catalysts. Formulation of a supported catalyst comprising carbon nitride and carbon black also provides an effective electrocatalyst. Preliminary results from experiments with fuel cells formed using carbon nitrides metalated with platinum yield attractively shaped power curves with respectable power density. Metalated carbon nitride materials may be incorporated into electrodes as components of a fuel cell assembly, such as a functioning proton exchange membrane (PEM) fuel cell assembly.

Without being bound by any particular theory, carbon nitride powders and films are believed to have a high concentration of nitrogen sites available for metal binding. It is also believed that these materials can bind more strongly to metal catalyst to their surfaces and thereby reduce metal migration out of the carbon nitride material.

General Methodology

Synthetic routes to carbon nitride (C₃N₄₊ₓH_{y} where 0≦x≦1 and 1≦y≦2) powders based on the thermal decomposition of various nitrogen-rich molecular precursors have been 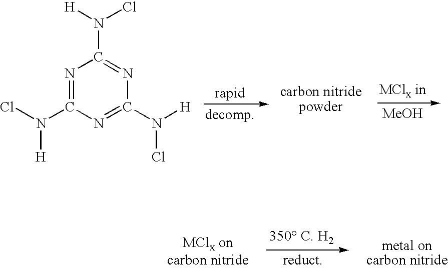
developed. The semiconducting powders are inert to concentrated acids and bases and are intended to chelate metals through the numerous nitrogen lone pairs (N/C ratios>1). The extended carbon nitride structure may be formed, for example, by rapid pyrolysis of an inexpensive starting material, (e.g. trichloromelamine). A metal catalyst component (e.g., Pt, Ni) may be included in the starting mixture or deposited once the carbon nitride structure is formed. Reproducible metal loadings of 10-40 wt % may be achieved, but a heterogeneous distribution of metal structures is likely. For example, metal may be deposited on the carbon nitrides by rapid drying of a slurry of carbon nitride and metal chloride and subsequent hydrogen reduction at 350° C. (Carbon nitrides are stable to 500° C.) Metals coated to date include Pt, Ni, Ag, Co, V, Mn, and Cu. Several of these metals show effective oxygen reduction in the presence of methanol when the metals are supported on pyrolyzed porphyrins.

Carbon nitride films made by other synthetic routes may also be utilized in preparation of supported metal catalysts including, for example, U.S. Pat. No. 6,428,762 to Khabashesku et al. entitled “Powder Synthesis and Characterization of Amorphous Carbon Nitride, A-C₃N₄,” and U.S. Pat. No. 5,606,056 to Kouvetakis et al. entitled “Carbon Nitride and Its Synthesis” the disclosures are hereby incorporated by reference. Chemical vapor deposition of carbon nitride films with variable nitrogen content yields materials that range from electrically conducting doped graphites to nitrogen-rich carbon nitrides. Nitrogen content of films is controlled by choice of precursor and deposition temperature.

Carbon nitrides may be deposited on carbon cloth at temperatures from 300 to 800° C., a range over which carbon cloth is stable. Metal catalysts may then be deposited using strategies developed for the powders. The metal on carbon nitride on cloth structure provides a planar structure that may be evaluated as a MEA electrode. The process is amenable to large scale deposition of catalyst structures.

Significant improvement in powder conductivity have been observed with additives, such as carbon black. Rapid pyrolysis of trichloromelamine in the presence of carbon black produces visually homogeneous, black materials. Appreciable bulk electronic conductivity was found for carbon black contents>25%. These composite supports may be coated with metal catalysts and used to form membrane electrode assemblies (MEAs). The better intermingling of catalyst and conductor is believed to provide superior electrocatalytic structures. High conductivity, stability, and intimate mixture between catalyst and conducting support has the potential to simplify and perhaps standardize MEA construction. A well-integrated supported electrocatalyst provides sufficient electronic conductivity that electron transport between the current collectors and electrocatalysts does not affect performance. The fuel cells tested were formed by physically compounding 50:50 carbon nitride catalyst and carbon black with a mortar and pestle. The process was not optimized. Carbon black enhances electronic conductivity. Two alternative formulations may provide better fuel cell electrocatalysts: incorporation of conducting additives during the rapid pyrolysis and deposition of carbon nitride on carbon cloth.

Bimetallic catalysts may improve CO tolerance and have shown twice the reduction efficiency for oxygen in the presence of methanol versus monometallic analogs on porphyrins. Bimetallic suspended catalysts may also be prepared in accordance with the invention, including Co/Fe or Ru/Pt combinations. Solution or H₂ reduction methods with multiple metal precursors may be use to form bimetallics on carbon nitride supports. Surface functional groups on the carbon nitride may also be modified. Such modifications may be used, for example, to augment binding and control hyrophobicity/hydrophilicity characteristics of the support including at potential metal catalyst binding sites. For example, the N—H residues of the carbon nitride materials can be modified with organochlorides such as XSO₂Cl to generate sulfonamides (>N—SO₂X where X=H, CF₃, or alkane). Other methods for metal deposition designed to produce more homogeneous deposits may also be employed including: solution phase pre-reduction of metal ions may lead to better dispersion on suspended supports, and metal nanoparticles including pre-formed metal nanoparticles may be adsorbed onto or otherwise bound to the carbon nitride surface.

Materials Characterization

Promising catalytic activity has been demonstrated for metal catalysts supported on carbon nitride structures. Characterization of these catalysts may be accomplished by materials evaluation such as by SEM/EDS, XPS, XRD, and IR as well as electrochemical assessment through voltammetry and fuel cell studies of substrates important to fuel cell technology. Metals deposited in various ways and on various carbon nitride supports (i.e., powders and films) may be evaluated by these procedures.

Bulk metal crystallinity may be determined by powder X-ray diffraction (XRD). Bulk compositional analysis may be derived from combined CHN combustion and ICP/AA results. Composite thermal stability may be determined using thermogravimetric-differential thermal analysis. Surface coordinated molecular species and structural modifications of the carbon nitride framework may be probed with IR spectroscopic methods.

At the next level of resolution but above the molecular level, the metalated carbon nitride may be assessed for dispersion, homogeneity, and compositional purity by scanning electron microscopy (SEM) and energy dispersive spectroscopy (EDS). These methods map surface structures of reduced metal and metal distribution across several microns. Higher resolution structural, compositional, and nanoscale diffraction data may be obtained using transmission electron microscopy (TEM).

On a more molecular scale, scanning X-ray photoelectron spectrometer (XPS, includes Auger and ultraviolet photoelectron spectroscopies) identifies oxidation states and local surface chemistry (e.g., Pt versus PtN, PtO, or PtO₂). The available XPS maps elemental spatial distributions with oxidation state selectivity across large areas with resolutions down to 10 μm. XPS peak structures provide information about the type and extent of interactions between the bound metal and the carbon nitride network atoms.

Integration of characterization information with identified effective electrocatalysts provides a basis for identifying the dispersion, loading, and structural and binding characteristics important to stable and effective catalysis.

Electrochemical Objectives

The electrochemical objectives are divided into tests of stability, electrocatalytic activity, and effectiveness in a fuel cell environment. The information provided by these tests feeds back into the design and optimization of the various embodiments of the carbon nitride supported catalysts.

One of the major limitations to current fuel cell technologies is the lack of catalyst stability in an operational fuel cell, especially under load cycling. Most MEAs are compounded by suspending a commercial supported catalyst in NAFION® suspension and applying the resulting ink to a conductive substrate, such as carbon cloth. An alarming observation is that commercial catalyst is not stable in NAFION® suspension for even brief periods, with visible changes to the solution in as little as an hour. Thus, supported catalysts stable in NAFION® suspension are attractive as such materials may be stable for an extended period in a fuel cell environment (i.e., resist Ostwald ripening). Analysis of the components of both the carbon nitrides catalysts of the invention and commercial catalysts in NAFION® suspension may be undertaken to assess stability.

Electrocatalytic activity of various metalated carbon nitride materials may be evaluated at paste electrodes in solution. Substrates of interest and challenge in fuel cells may be assayed, including oxygen, carbon monoxide, and methanol. Promising materials may be tested in a fuel cell. This may allow high throughput screening of a range of catalyst materials.

MEA structures may be optimized for each carbon nitride material and the fuel cells tested for the promising substrates. In this way, a wide range of materials including powders and films as well as alternative catalyst metals and metal structures can be evaluated. The most promising materials may be run in the fuel cell for an extended period; a post mortem analysis by SEM may determine whether Ostwald ripening has been suppressed by the carbon nitride support. Results may be compared to commercial catalysts.

The stability of these electrocatalysts can be exploited through improved metal deposition and materials structures. The stability of the materials may be further evaluated. Materials may be tested for voltammetric activity against substrates of interest in fuel cell technology. Promising materials may be evaluated in a fuel cell for both activity and stability. Metalated carbon nitride structures have the potential to provide lower cost, higher stability electrocatalysts for fuel cell applications.

General Methodology

Trichloromelamine (TCM, purchased from Aldrich Co.) is rapidly heated to ˜185° C., causing its decomposition to thermally stable carbon nitride powders with a formula of approximately C₃N_{4.5}H_{1.5} with N and H values varying by about ±0.5, depending on preparation and processing. This nitrogen-rich solid material is not a defined single phase, but a disordered polymeric material of slightly varying composition.

Commercial carbon black was mixed with the TCM precursor before decomposition and processing, leading to products with carbon nitride: carbon black weight ratios ranging of 90:10, 75:25, and 50:50. The 50:50 ratio showed two-probe electrical resistance comparable to the carbon black (˜50Ω), while the others were insulating or poorly conducting. Carbon black was also physically mixed with metalated carbon nitride powders to produce microscopically mixed conducting composites.

Methanol solutions of dissolved metal halide salts were evaporated under vacuum in the presence of stirred carbon nitride powder. These solids were transferred to a glass flow tube in a furnace and heated to 350° C. under a 10% H₂/90% N₂ flow, reducing the metal salts to elemental crystalline or amorphous metal coatings on the carbon nitride.

The electrochemistry of the metal on carbon nitride materials were examined using paste electrodes (mineral oil, carbon black and metal on carbon nitride mixtures). This testing included oxygen reduction, CO electrochemistry, and methanol oxidation.

Catalysts may be assessed for activity toward substrates of importance in PEM fuel cells (i.e., O₂, CO, and CH₃OH) by cyclic voltammetry at paste electrodes compounded with catalyst and carbon black.

Pt on carbon nitride was mixed with carbon black and inked onto a fuel cell electrode, and incorporated into a PEM fuel cell assembly. This assembly provided stable power outputs in both H₂/O₂ and H₂/air fuel cell systems with reasonable power densities.

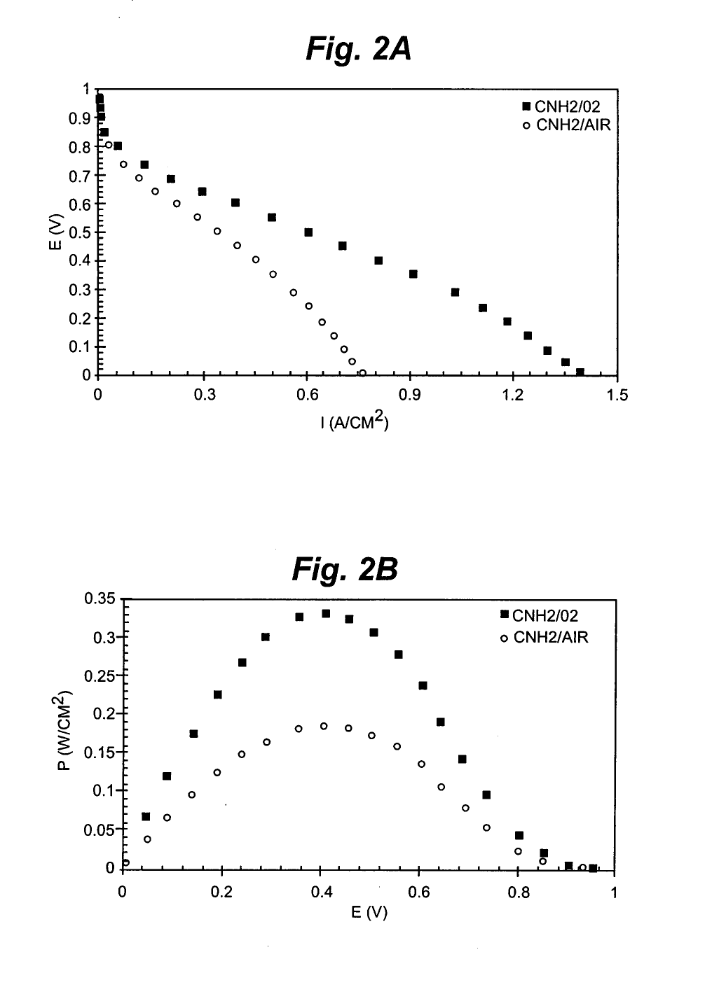

The platinum catalysts have been most active voltammetrically toward fuel cell substrates. Three catalysts have been evaluated in the fuel cell and the two carbon nitrides coated with Pt by deposition show activity. Pyridine-washed Pt carbon nitride (40 wt % Pt) was compounded with carbon black with a mortar and pestle at 50:50 and deployed on the anode; the cathode was 20 wt % Pt on carbon (ALFA AESAR® HISPEC™ 3000 available from Alfa Aesar of Ward Hill, Mass.). Data and conditions are shown in FIG. 2; similar results were found for the methanol-washed materials. The maximum power was 0.33 W/cm² at 0.40 V on O₂ and 0.20 W/cm² at 0.46 V on air. For comparison, a control with HISPEC™ on the anode (0.37 mg/cm²) and cathode (0.47 mg/cm²) yielded 1.04 W/cm² at 0.46 V on O₂ and 0.48 W/cm² at 0.56 V on air. The costs for 10 wt % Pt ALFA AESAR® and carbon nitride catalysts are comparable ($25/g and ˜$18/g); however the carbon nitrides are stable in a NAFION® suspension.

Catalyst stability may be assayed by soaking the catalyst in commercial NAFION® suspension. Note that platinized VULCAN® XC-72 is surprisingly unstable when introduced into a NAFION® solution with the solution changing color from clear to green to black in about an hour. The Pt on carbon nitride is markedly more stable in NAFION® solutions than commercial Pt on carbon black. After more than 2.5 months the platinum did not dissolve from the carbon nitride after being placed in a NAFION® solution, whereas it quickly (˜12 hours) dissolved from the carbon black support.

Preliminary Results

Preliminary electrochemical stability examinations were conducted and indicate that the carbon nitrides are robust and inert under conditions that are representative of fuel cell environments. Several metal incorporation strategies were examined, including metal salt adsorption and reduction by chemical means at either ambient temperatures (hydrazine) or elevated temperatures (H₂), with the latter method being more universally successful. Incorporated metals include Pt, Ni, Cu, Co, Mn, V, and Ag.

Several of the metal impregnated carbon nitride materials were mixed with conducting carbon black and electrochemically examined in a carbon paste electrode test system. Preliminary tests focused on Pt and Ni systems. The conducting composites were studied by cyclic voltammetry in Na₂SO₄ solutions purged with N₂ (control), saturated with either O₂ or CO gases, or dosed with methanol. Several of the metal impregnated carbon nitride/carbon black electrodes performed either equivalently or better than control electrodes, including commercial Pt on carbon and Pt disks.

Production and Thermal Investigation of Carbon Nitride

Materials Synthesis of Nitrogen-Rich Carbon Nitride Networks

The nitrogen-rich carbon nitride materials used were produced by the rapid heating (˜150° C./hr) of an inexpensive, commercially available (Aldrich Co.) molecular triazine (C₃N₃) precursor, trichloromelamine [TCM, (C₃N₃)(NHCl)₃]. The precursor decomposition process was performed in a 125 ml stainless steel Parr reactor using a custom-made Glas-Col heating mantle and an Omega Engineering temperature controller. Several experiments were performed using TCM precursor amounts on the order of 5 g (22 mmol). When the Parr reactors internal temperature reached ˜185° C., the analog pressure gauge attached to the reactor recorded a rapid pressure jump (300 psi for 5 g of precursor). Most of the evolved gas consists of HCl and nitrogen (Equation 1), although for mass balance there may be trace amounts of chloramines or chlorine gas also produced.

$$( {C}_{3} {N}_{3} ) {( N H C l )}_{3} \to {C}_{3} {{N}_{4 + x} ( H )}_{y} + ( 3 - y ) H Cl + ( 2 - x ) \text{/} 2 {N}_{2} x \approx 0 - 1 , y \approx 1 - 2 \qquad ( 1 )$$

There is residual hydrogen in the product, likely present as N-H bonds, regardless of decomposition method, indicating that the hydrogen arises from the TCM precursor. The isolated carbon nitride products were vacuum annealed at 250° C. to ensure any reactive or dangling bonds were stabilized or removed. The amount of isolated tan-orange product in these large-scale reactions corresponds to a 25-30 wt % yield based on precursor starting mass, which is equivalent to a near quantitative conversion of triazine rings into the product structure. This TCM decomposition was also performed using 10 g of precursor, leading to larger scale carbon nitride production.

It is significant to realize that the carbon nitride (C₃N₄₊ₓ) materials are formed under very hot and corrosive acidic conditions, facts that bode well for its chemical stability in acidic fuel cell environments.

Production of Carbon Nitride—Carbon Black Composites Physical Mixtures of C₃N₄₊ₓ and Carbon Black (VULCAN® XC-72)

To improve the electrical conduction of nitrogen-rich carbon nitride, several experiments were performed using conducting carbon additives. It was initially assumed that percolation limits (16 wt % of a conductive material mixed with a non-conducting phase) would be applicable to composites formed from physical mixtures of semiconducting carbon nitride with conducting carbon black (VULCAN® XC-72, Cabot Company ˜200 nm aggregate size). Two-probe electrical resistance measurements were performed on cold-pressed pellets of intimately ground physical mixtures of C₃N₄₊ₓ and carbon black. These composite pellets had fairly poor integrity, similar to the pure C₃N₄₊ₓ pellets. As is shown in Table 1, the electrical resistance of the physical mixtures approaches that of pure carbon black by a 25 wt % addition level.

TABLE 1
Comparison of electrical resistance of physically
prepared C₃N₄₊ₓ - carbon composites

| Pellet composition | 2-probe | |
|---|---|---|
| (wt % ratio) | electrical | |
| C₃N₄₊ₓ: carbon black | resistance (Ω) | Pellet appearance/homogeneity |
| 0:100 | 30 | black homogeneous, brittle/fragile |
| 50:50 | 80 | black and yellow - heterogeneous, brittle |
| 75:25 | 60 | black and yellow - heterogeneous, brittle |
| 90:10 | ˜1000 | black and yellow - heterogeneous, brittle |
| 100:0 | >10⁵ | tan-orange, homogeneous, moderate pellet integrity |

All of the samples listed above were hand-mixed using a mortar and pestle. Further improvements in homogeneity and mixing in these physically combined systems are possible using ball-milling or other high energy mixing techniques.
Rapid in-situ Formation of C₃N₄₊ₓ—Carbon Black Composites

One significant advantage of the method utilized to form the carbon nitride materials described herein, is that their formation is rapid (a few seconds) and exothermic (temperature elevation to ˜400° C.). Previous electron microscopy evidence suggests that there is some gas phase recondensation and melting that occurs during synthesis. In order to produce submicron scale mixing of C₃N₄₊ₓ with carbon black, the decomposition of the TCM precursor was conducted in the presence of varying amounts of carbon black. The precursor was intimately ground with the carbon black and then rapidly decomposed using a home-built heated wire ignition reactor. This reactor allows both a quick survey of various TCM:carbon black ratios and preparation of composites on small (˜0.5 g) initial scales. The products from this in-situ composite formation reaction are noticeably distinct from the physical mixtures noted in the “Physical Mixtures of C₃N₄₊ₓ and carbon black (VULCAN® XC-72” section above. The in-situ products are visibly homogeneous even under an optical microscopic (200×) examination. Cold-pressed pellets of these in-situ produced composites also have significantly better integrity and higher electrical resistance (Table 2) than observed for equivalent physical mixtures. The pure carbon black and pure carbon nitride results listed in Table 1 are listed again in Table 2 for ease of comparison and trends.

TABLE 2
Comparison of electrical resistance of in-situ
prepared C₃N₄₊ₓ - carbon composites

| Pellet composition | Composition (wt %) | | |
|---|---|---|---|
| (wt %) | and overall formula | 2-probe | |
| C₃N₄₊ₓ: carbon | based on elemental | electrical | Pellet |
| black * | analysis* | resistance (Ω) | appearance/homogeneity |
| 0:100 | 99+% C | 30 | black homogeneous, |
| | | | brittle/fragile |
| 50:50 | 50 [C₃N_{7.47}H_{6.07}]: | 60 | black, slightly iridescent, |
| | 50 [C] | | homogeneous, excellent |
| | or C₃N_{1.33}H_{1.09} | | integrity |
| 75:25 | 75 [C₃N_{5.12}H_{3.3]:} | | black iridescent, |
| | 25 [C] | 3000 | homogeneous, excellent |
| | or C₃N_{2.45}H_{1.53} | | integrity |
| 90:10 | not analyzed | >10⁵ | iridescent black with yellow |
| | | | and brown spots, excellent |
| | | | integrity |
| 100:0 | C₃N_{4.19}H_{2.38} | >10⁵ | tan-orange, homogeneous, |
| | | | moderate pellet integrity |

*based on amount of product isolated, assuming no carbon black loss.

To produce a composite with resistance comparable to pure carbon black, it was necessary to raise the amount of conducting carbon black to 50 wt %. This contrasts with the physical mixtures (Table 1) that only required a 25 wt % carbon black addition to achieve the same conduction threshold. These resistance results suggest that the carbon black particles are efficiently coated and sequestered by semiconducting carbon nitride coatings.

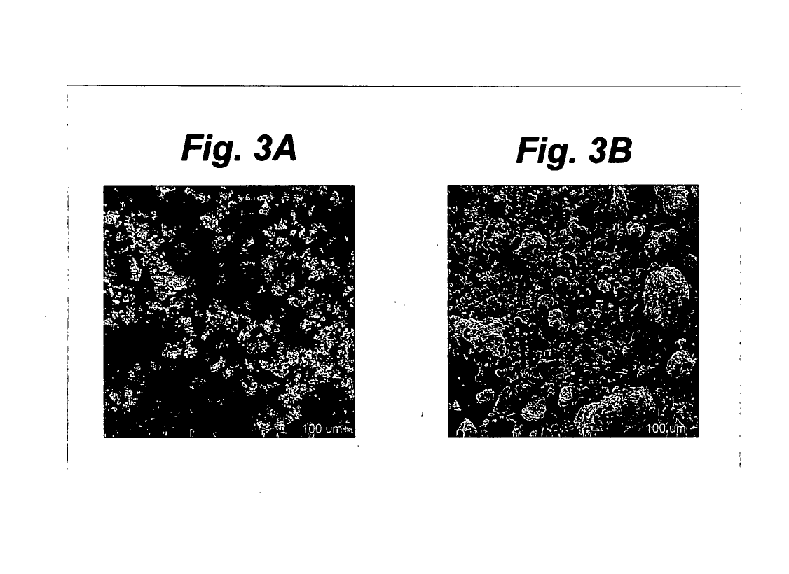

The microstructure and morphology of the 50:50 wt % C₃N₄₊ₓ—carbon black composite is markedly different than that of the pure carbon nitride. FIG. 3 shows a comparison of scanning electron microscopy images for these two materials. The ground pure carbon nitride is a fine particulate powder (FIG. 3 left). The in-situ composite reaction process results in carbon black particles that are fused together into larger masses nearly 1 mm in size that are held together by carbon nitride “glue.” These masses are easily ground to a fine homogeneous powder (FIG. 3 right), which still has larger aggregate sizes than the pure carbon nitride.

Several efforts were made to improve the conductivity of poorly conducting in-situ mixed 75:25 sample using thermal processing similar to that described in the “Attempted Graphitization of C₃N₄₊ₓ Materials” section above. Since the C₃N₄₊ₓ material is in intimate contact with the carbon black particle surface, the inherent carbon nitride volatilization should decrease due to enhanced carbon nitride reaction with the dangling bonds on the carbon black surface. This would result in more intimate electrical contact between the particle and surface coating, leading to an increase in the electrical transport through the composite. Initial annealing attempts on in-situ 75:25 pellets shows that conductivity improved to ˜200Ω after prolonged heating at 600° C. under dynamic vacuum, but this was accompanied by an unacceptable degree of carbon nitride volatilization, as observed visually and by sample weight loss.

Examination of Electrochemical Characteristics of Carbon Nitride Materials

Pure C₃N₄₊ₓ Network Materials

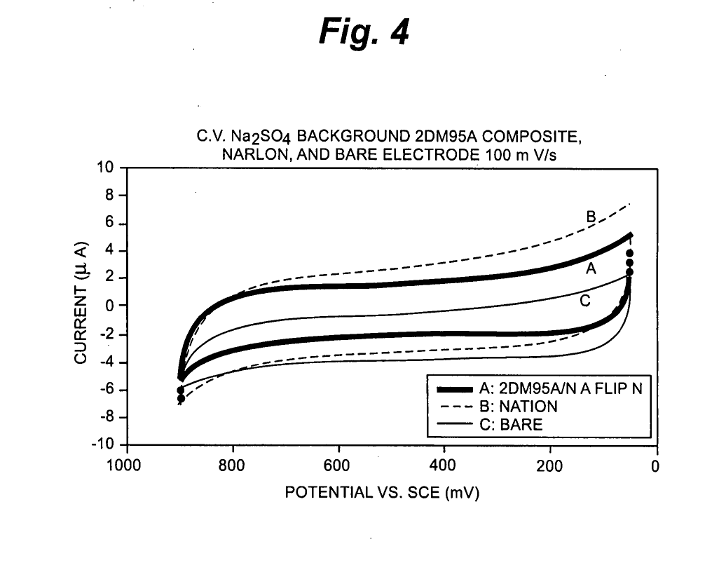

The electrochemical stability of the pure carbon nitride material was investigated by affixing it to a carbon disk electrode using NAFION® (perfluorosulfonic acid polymer). The experiments were run with 15 wt % C₃N₄₊ₓ dispersed in a solution of NAFION® dissolved in aliphatic alcohol and cast onto the electrode surface (0.45 cm²). The electrodes were carefully dried to avoid film cracking. The carbon nitride material shows no significant electrochemical events over the 0.05 to 0.9 V range (vs SCE) in 0.1 M Na₂SO₄ (FIG. 4). It showed similar stability characteristics when the same cycling was performed in a 0.1 M HNO₃ solution. In either solution, the cyclic voltammetry was qualitatively similar to that of a NAFION®-coated carbon disk electrode.

Physical Mixture of C₃N₄₊ₓ with Carbon Black

Due to the visible heterogeneity of physically mixed composites, it seemed likely that these systems would show electrochemical stability similar to that of the pure carbon nitride materials (“Pure C₃N₄₊ₓ network materials” section above). Preliminary testing and analysis showed that physical composites with a 50:50 weight ratio of carbon nitride and carbon black (VULCAN® XC-72) were acceptably electrically conducting to carry out further electrochemical measurements.

In-situ Mixture of C₃N₄₊ₓ with Carbon Black

The electrochemical stability of the homogeneous in-situ generated mixture of C₃N₄₊ₓ with carbon black (50:50 wt % ratio based on product ratio, pellet resistance=60Ω) was initially examined using a glassy carbon disk electrode. The experiments were run with 15 wt % of the C₃N₄₊ₓ/carbon black composite dispersed in a NAFION® matrix. The cyclic voltammetry of this material in 0.1 M Na₂SO₄ and 0.1 M HNO₃ showed no events other than those observed for pure NAFION®-coated carbon electrode.

Examination of C₃N₄₊ₓ and Carbon Black Composites in Presence of Redox Processes

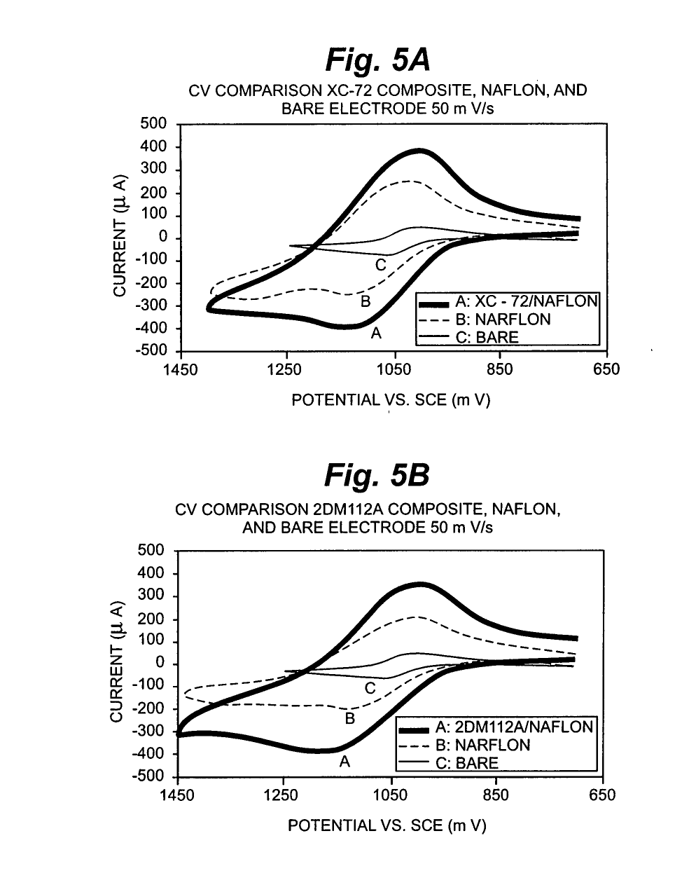

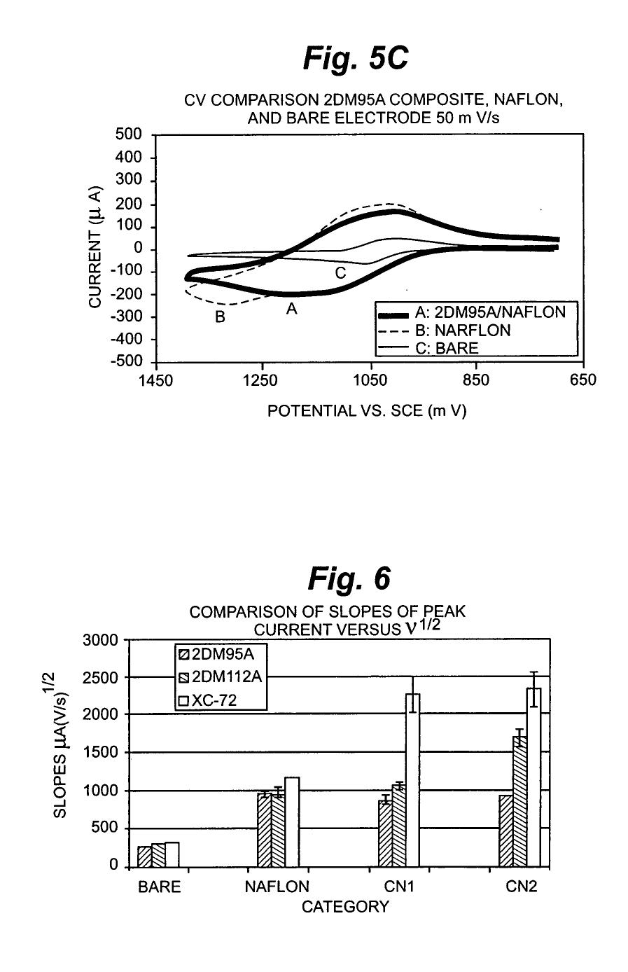

After determining that the carbon nitride materials are electrochemically stable in acidic solution, their electroactivity in the presence of a redox test sample was investigated. A series of electrodes (bare carbon, NAFION® (from DuPont) only, NAFION® with 15 wt % carbon black [XC-72], NAFION® with C₃N₄₊ₓ[2DM95a], and NAFION® with 15 wt % of the in-situ C₃N₄₊ₓ/carbon black mixture [2DM112a]) were exposed to a solution of 1.0 mM tris(2,2′-bipyridyl)dichlororuthenium(II) hexahydrate in 0.1 M HNO₃ for 12-18 hrs to ensure complete exchange of the Ru²⁺ complex into the NAFION® film on the electrode. Cyclic voltammetry (50, 75, and 100 mV/s) was performed to investigate the Ru²⁺/Ru³⁺ redox behavior in the presence of the various electrode constituents. Representative CV scans for this redox process are shown in FIG. 5 for the 5 different electrodes compositions noted above.

These scans show that the carbon black containing electrodes have the highest current flow of all samples. The pure carbon nitride containing electrodes (2DM95a) do not enhance or significantly hinder the ruthenium redox process relative to the pure NAFION® coated electrode. There is a slightly lower current maximum observed for the pure carbon nitride containing electrodes relative to NAFION® that can be explained based on a semiconducting filler (C₃N₄₊ₓ) hindering conduction of the ruthenium complex. The electrodes containing the 50:50 wt % in-situ C₃N₄₊ₓ—carbon black additive (2DM112a) show slightly less current flow than the pure carbon black containing electrode, consistent with the presence of the semiconducting carbon nitride filler (nominally 7.5 wt %).

FIG. 6 plots the slopes of peak current versus square root of the scan rate (υ^{1/2}) obtained from the CV data (c.f. FIG. 5) for a set of 4 electrodes used in a series of 3 replicates. Each experiment included a bare carbon electrode, a carbon electrode coated with NAFION®, and duplicate electrodes coated with NAFION® containing 15 wt % of a filler material (CN1 and CN2: filler was pure carbon black—XC-72, pure C₃N₄₊ₓ—2DM95A, or the in-situ mix of C₃N₄₊ₓ with carbon black—2DM112A).

Assuming that diffusion and concentration of redox species is constant, the slope reflects a change in apparent electrode area and is roughly proportional to the amount of carbon black added to the electrode. These results are consistent with the presence of a filler containing semiconducting carbon nitride along with an electrically active carbon black. Notably, adding the carbon nitride filler to NAFION® does not appreciably alter the peak current achievable by NAFION® alone.

Synthesis and Electrochemistry of Metal Containing Carbon Nitride-Carbon Black Composites

Chemical Preparation of Metal-C₃N₄₊ₓ Composite Structures

The chemical reduction and surface binding of several metals onto the carbon nitride framework was investigated by several methods. Initial ambient temperature solution reductions of the several metal salts with hydrazine in the presence of carbon nitrides were only partially successful. The lack of crystalline metal peaks by powder X-ray diffraction and observed halide residues indicated that hydrazine was not a strong enough reducing agent. Self-reduction of H₂PtCl₆ in methanol at 60° C. did produce a black coating on suspended tan carbon nitride powder, but powder XRD analysis showed it to primarily consist of PtO₂. Metal salts were combined with TCM and carbon nitride formation performed in the heated filament reactor. These resulted in partially reduced salts mixed in the carbon nitride network with moderate heterogeneity and were not investigated further.

A more successful iteration involved the creation of slurries of the C₃N₄₊ₓ powders (from the large scale Parr reactor decomposition) with a dissolved metal salt in methanol. The solution was evaporated to dryness under vacuum, yielding an intimate mixture of a metal salt and the carbon nitride network. This dried metal salt/C₃N₄₊ₓ mixture was placed in a PYREX® tube and subjected to flowing 10% H₂ (balance N₂) at 350° C. for 24 hrs. In many cases, this produced crystalline metal after reduction (see Table 3). This method was the preferred preparation method for metal/C₃N₄₊ₓ composite formation. The samples listed in Table 3 represent a small fraction of those synthesized and analyzed. Specifically the data are for samples produced from pyridine pretreated carbon nitride materials (see next section).

TABLE 3
Comparison of several metal - carbon
nitride incorporation experiments

| Metal salt | | XRD result | Metal residue after |
|---|---|---|---|
| (M:C₃N₄₊ₓ target | Color after | after H₂ | TGA in Ar to 1000 |
| weight ratio) | H₂ at 350° C. | reduction | ° C. (wt %)* |
| H₂PtCl₆ (10:90) | grey | Pt metal | 10.8 (Pt) |
| H₂PtCl₆ (50:50) | grey | Pt metal | 34.8 (Pt) |
| CuCl₂•2H₂O | red-brown | amorphous | 8.2 (CuO) |
| (10:90) | | | |
| NiCl₂•6H₂O | grey-green | Ni metal | 12.6 (Ni, NiO) |
| (10:90) | | | |
| CoCl₂•6H₂O | grey-green | amorphous | 9.4 (Co) |
| 10:90) | | | |
| MnCl₂ (10:90) | orange-tan | amorphous | 6.2 (Mn₃O₄) |
| VCl₃ (10:90) | grey | amorphous | ≦10 (VOₓ) |
| AgNO₃ (10:90) | grey | Ag metal | 9.1 (Ag) |

*XRD identified material in TGA residue is noted in parentheses

Effect of Pyridine Pretreatment on Metal Binding to Carbon Nitride Materials

In preliminary experiments examining metal salt binding to carbon nitride, it was observed that dissolved metals appear to adsorb more readily or “stick” to C₃N₄₊ₓ powders that were pretreated with a strong organic base (e.g. pyridine, C₅H₅N, py) as compared to the as-synthesized products. Because the as-synthesized carbon nitride materials contain residual hydrogen, likely present as amine moities (>NH or —NH₂), the pyridine may activate the carbon nitride nitrogen surface states, with the pyridinium cation (pyH⁺) serving as a placeholder near the activated nitrogen site until the metal salt replaces it and binds to the nitrogen site, releasing py-HCl into solution (Scheme 1). Several experiments described in Table 3 were performed under identical metal salt incorporation conditions with and without pyridine pretreatment of the carbon nitride. Scheme 1 shows how these two routes may lead to metal incorporation in the C₃N₄₊ₓ network. One potential advantage of the pyridine pretreatment is that the metals may be more intimately associated with the carbon nitride network structure, as compared to the process without pretreatment. 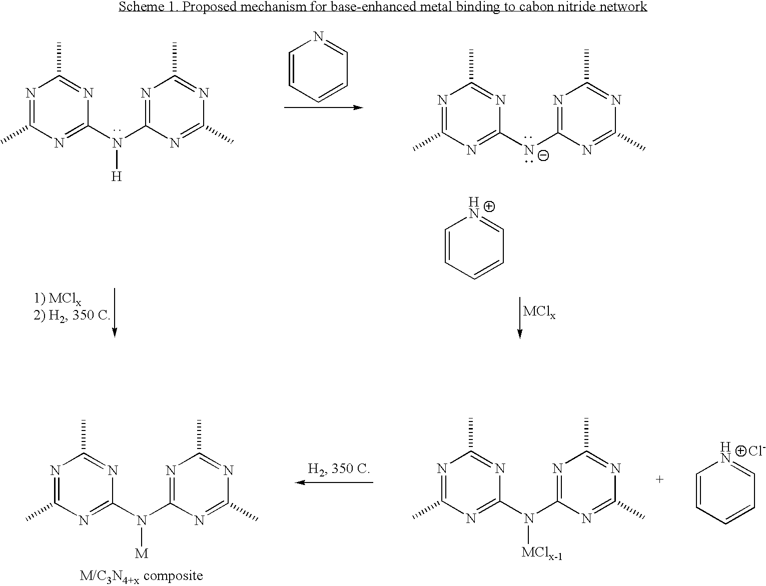
There is evidence that pyridine species remain strongly associated with the carbon nitride network after the pyridine wash process. The pyridine treated C₃N₄₊ₓ powders were isolated and washed with methanol, but when they were resuspended in metal salts, e.g., CuCl₂ or H₂PtCl₆, dissolved in methanol, there is solution evidence for the formation of (pyridine)₂MClₓ. Specifically, when the solutions are recovered after exposure to the pyridine treated carbon nitride and evaporated to dryness, the reprecipitated solids contains powder XRD evidence for pyridine metal salts such as (pyridine)₂CuCl₂ and (pyridine)₂PtCl₄. Other related Lewis basic amines were examined for carbon nitride pretreatment chemistry, specifically triethylamine and ethylenediamine. Preliminary results suggest that ethylenediamine may activate the nitride surface similarly to pyridine, but additional studies are needed to verify these initial results. A potential advantage of ethylenediamine is its lower cost relative to pyridine.

The in-situ generated C₃N₄₊ₓ—carbon black composite materials were also metal impregnated in a manner similar to that described above, but preliminary electrochemical studies did not show distinct advantages associated with these carbon black composites (“co-mingled” materials) as compared to M/C₃N₄₊ₓ products (described above) that were physically mixed with carbon black (“blended” materials) after metal impregnation. In the interest of rapid facile survey of several metal-carbon nitride materials, most of the electrochemical studies described below focus on M/C₃N₄₊ₓ powders that were intimately mixed with ˜50 wt % of VULCAN® XC-72 carbon prior to electrochemical analysis. Because the in-situ generated C₃N₄₊ₓ—carbon black composites are inherently conductive, they provide an additional degree of chemical tuning that can be exploited in future studies on these systems.

Electrochemical Examinations of Metal-Carbon Nitride Composites

Preparation of Composite Carbon Paste Electrodes

For simplicity and rapid screening reasons, the metal-carbon nitride composite electrochemical studies were conducted using carbon paste electrodes. A majority of the metallated carbon nitride materials used in carbon paste electrodes consisted of pure metal-carbon nitride composites described in the “Chemical preparation of metal —C₃N₄₊ₓ composite structures” and “Effect of pyridine pretreatment on metal binding to carbon nitride materials” sections (above) that involved hydrogen reduction of metal salts impregnated into pure carbon nitride solids. These electrodes consisted of a ground mixture of the material of interest with typically 50 wt % of carbon black (VULCAN® XC-72) to achieve consistent electrical conduction. This dry mixture was converted to a thick paste with mineral oil (˜60 wt % of the sample). Because all of the metal containing carbon nitride samples were diluted by 50 wt % XC-72, the final amount of Pt in the dry mixture (prior to mineral oil mixing) was 5 wt %. After mixing these samples with mineral oil, Pt was ˜2 wt % of the total paste electrode weight. A similar procedure was used with a commercial standard 10% Pt on XC-72 (E-tek, Inc.).

The composite paste mixture was transferred to a 2 ml disposable polyethylene transfer pipet that was cut at the 0.25 ml mark to provide a tapered cylinder approximately 1.75″ long and open at both ends. The end of the tapered cylinder with the larger opening is considered the “top” of the completed electrode. A Pt wire was inserted into the top end of the electrode assembly to provide electrical contact between the carbon nitride-carbon black carbon paste electrode (CN-CPE) and the potentiostat.

Electrochemical Data Collection and Analysis

A Bioanalytical Systems (BAS) 100B Electrochemical Workstation with a saturated calomel electrode (SCE) reference electrode and Pt wire mesh counter electrode was used for all analyses. A 0.10 M aqueous Na₂SO₄ electrolyte solution was used to measure the capacitive background of all electrodes. These measurements provide a means to estimate the electroactive area of carbon paste electrodes. The solution was vigorously purged with N₂ for 10 to 15 minutes prior to any electrochemical measurements and a blanket of N₂ gas was maintained above the solution while measurements are taken. Capacitive backgrounds were taken at three scan rates (100, 300, and 500 mV/s). First, the BAS potentiostat measures the rest potential of an electrode. The potentiostat then scans negatively from the rest potential to −700 mV. The second segment consists of a scan from −700 mV to +1200 mV. The third segment scans from +1200 mV to −700 mV and the fourth segment from −700 mV to 1200 mV. The width of the capacitive envelope measured at +400 mV using segments 2 and 3 is proportional to the electrode area and was used to estimate the carbon paste electrode area relative to a Pt disk electrode of known dimensions. The reported relative current densities were calculated using these approximate electrode areas. Note that this estimate of electrode area may contain errors as great as 30% and greater errors are possible for systems containing metals other than platinum. Several controls were examined under similar conditions, including commercial 10% Pt on XC-72 (E-tek, Inc.), pure XC-72 (Cabot Corp.), and a Pt disk electrode.

Cyclic voltammetry was used to measure the electroactivity of the control and carbon paste electrodes towards several dissolved gaseous species that are relevant to fuel cell technology. In separate experiments, either carbon monoxide (CO) or oxygen (O₂) gas were vigorously bubbled through a 0.10 M Na₂SO₄ electrolyte solution for at least 10 to 15 minutes prior to electrochemical measurements. A blanket of gas was maintained over the solution while electrochemical measurements are taken. Electrodes are preconditioned under both gases prior to collecting data. Preconditioning consists of cycling the electrode between −700 mV and +1200 mV (vs. SCE) 100 times at 500 mV/s. Cyclic voltammograms were then recorded in a similar manner as described above for capacitive background analysis.

The electrochemical studies involving methanol (MeOH) utilized an aqueous solution consisting of 0.10 M Na₂SO₄ and 0.02 M MeOH. The MeOH solution was vigorously purged with N₂ gas for 10 to 15 minutes prior to making any electrochemical measurements. A blanket of N₂ gas was maintained over the solution while electrochemical measurements are taken. Electrode preconditioning and cyclic voltammogram recording were conducted as described above.

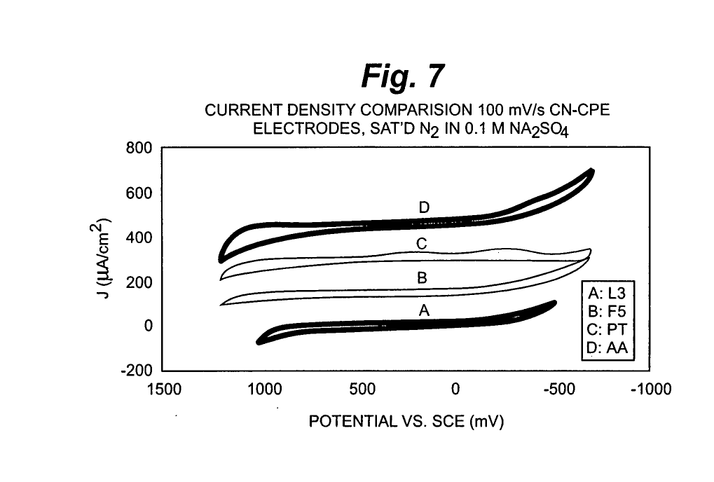

Representative scans in N₂ saturated solutions are shown in FIG. 7. FIG. 7 compares the background CV in N₂ for electrodes made from either a 50:50 physical mixture of Pt/C₃N₄₊ₓ or a commercial Pt on carbon sample mixed with carbon black (both are 2% Pt in bulk paste electrode). All electrodes exhibit similar morphologies.

Data tables describing the electrodes and sample conditions are compiled in the figures. Each table is ordered in descending order by ratio of sample current density ratio relative to that recorded for a platinum disk control electrode.

O₂ Electrochemical Results

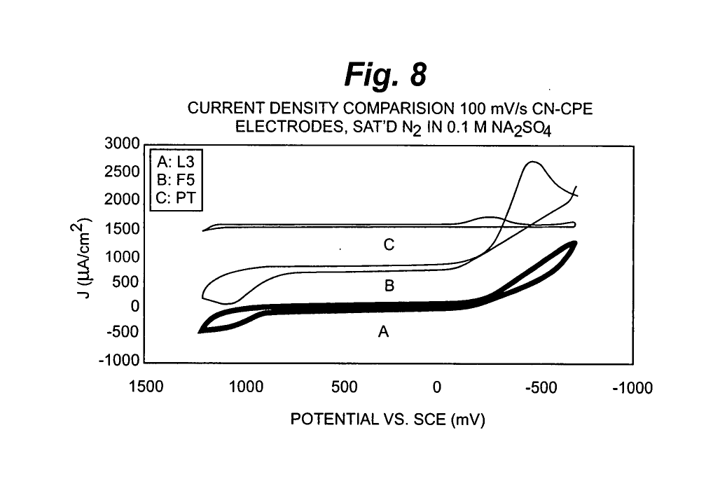

A key catalytic process that occurs at the cathode of a fuel cell structure is reduction of O₂. The metal containing carbon nitride/carbon black paste electrodes were examined in an O₂ saturated solution and their redox activity was compared to pure Pt disk electrodes and to an electrode made with commercial Pt on carbon black (XC-72). In general, most platinum containing carbon nitride samples exhibited faradaic response with an onset near −270 mV vs. SCE with a thin and somewhat sigmoidal shape, in contrast to the more well-defined waves observed for a 50:50 mixture of commercial 10% Pt on carbon with carbon black (2% Pt in the carbon paste electrode). FIG. 8 shows a comparison of CV data for these materials in a saturated O₂ solution.

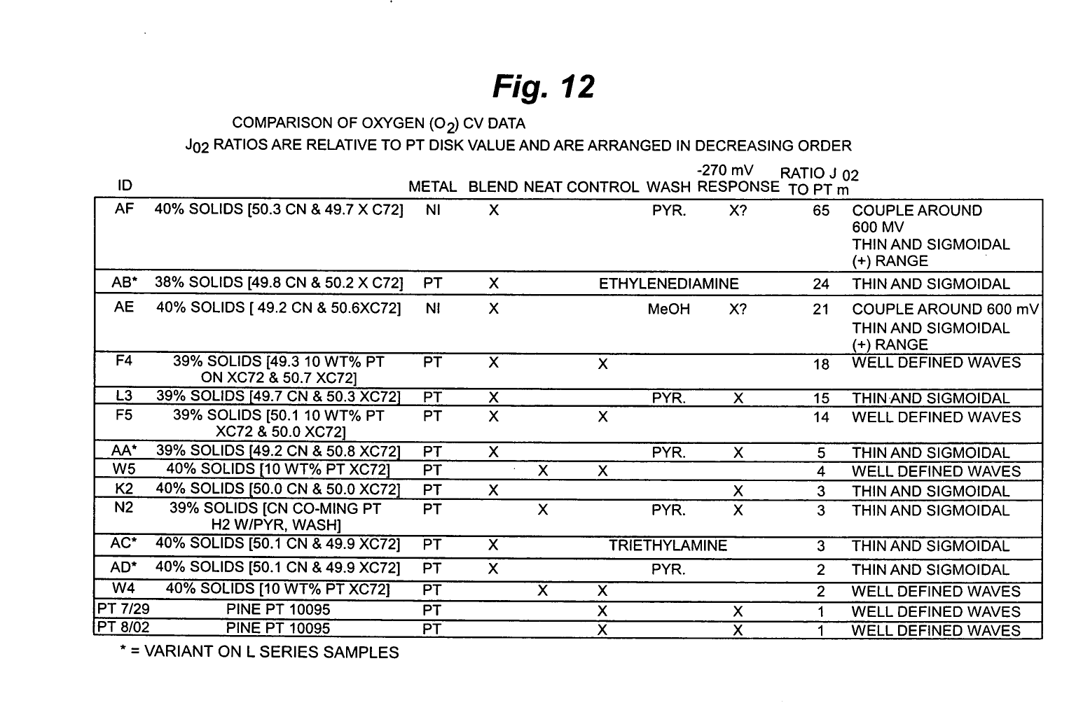

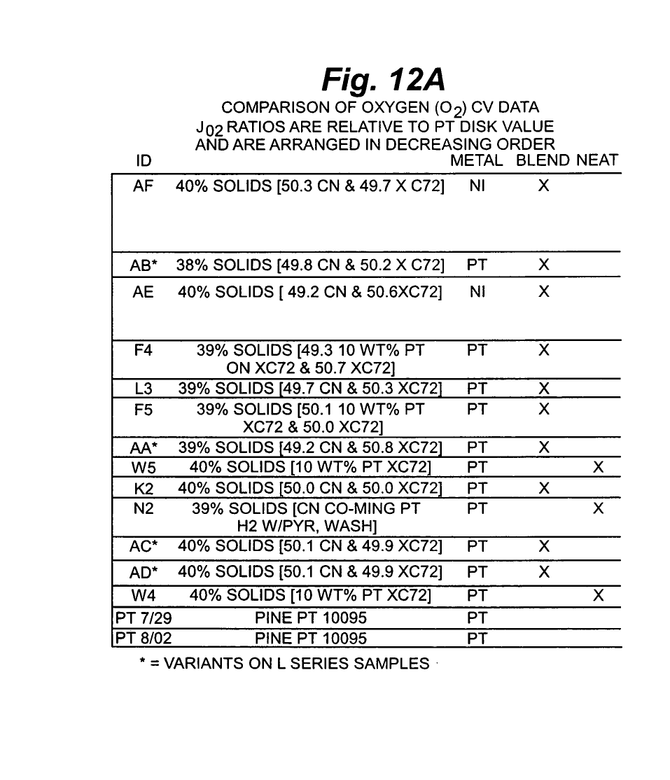

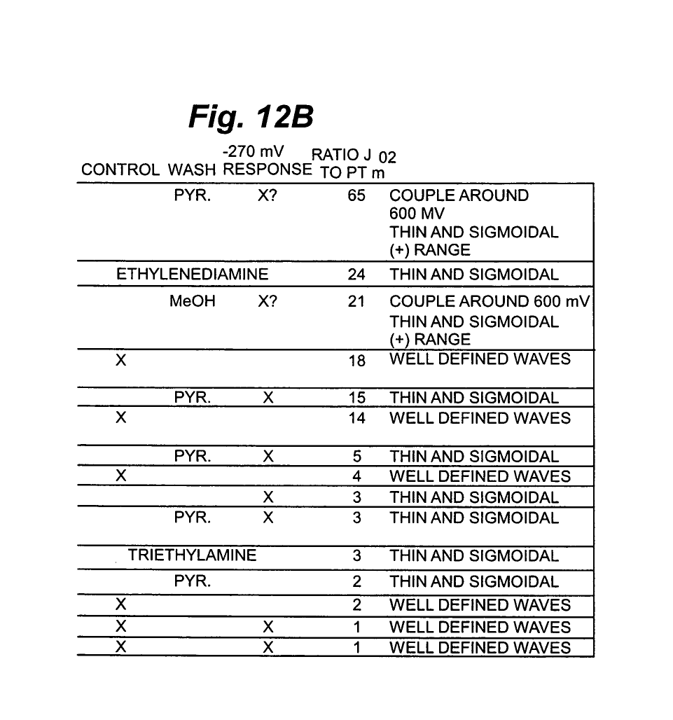

This electrochemical events in O₂ were observed both for Pt samples based on the co-mingled (carbon black incorporated during C₃N₄₊ₓ synthesis) and blended (carbon black added when preparing final electrode) materials (see FIG. 12). Similar to the Pt samples, nickel impregnated carbon nitrides also show thin and sigmoidal response near −270 mV. In addition, the Ni-carbon nitride electrodes show what appears to be a quasi-reversible redox couple with an Eₒ near 600 mV under O₂. These waves appear during electrode preconditioning and more investigation is necessary to determine their source. The Pt-carbon nitride composites have comparable current densities (J in μA/cm²) to those observed for the blended commercial Pt on carbon electrodes. For comparison, the commercial Pt standard recorded current densities 4 to 18 times greater than the Pt disk electrode, while several carbon nitride composites containing Pt registered current densities 2 to 24 times greater than the Pt disk control. The highest value of 65 for a Ni on carbon nitride sample is a bit uncertain because the surface area of the Ni electrodes is less well determined than the Pt electrodes, but there is still enhanced current density for the Ni systems, as well.

CO Electrochemical Results

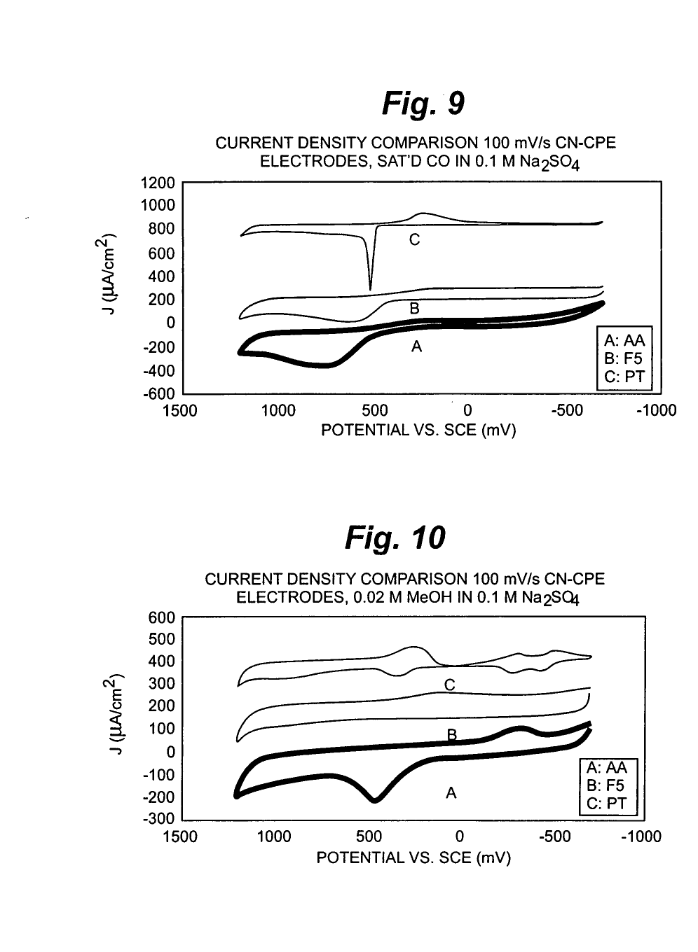

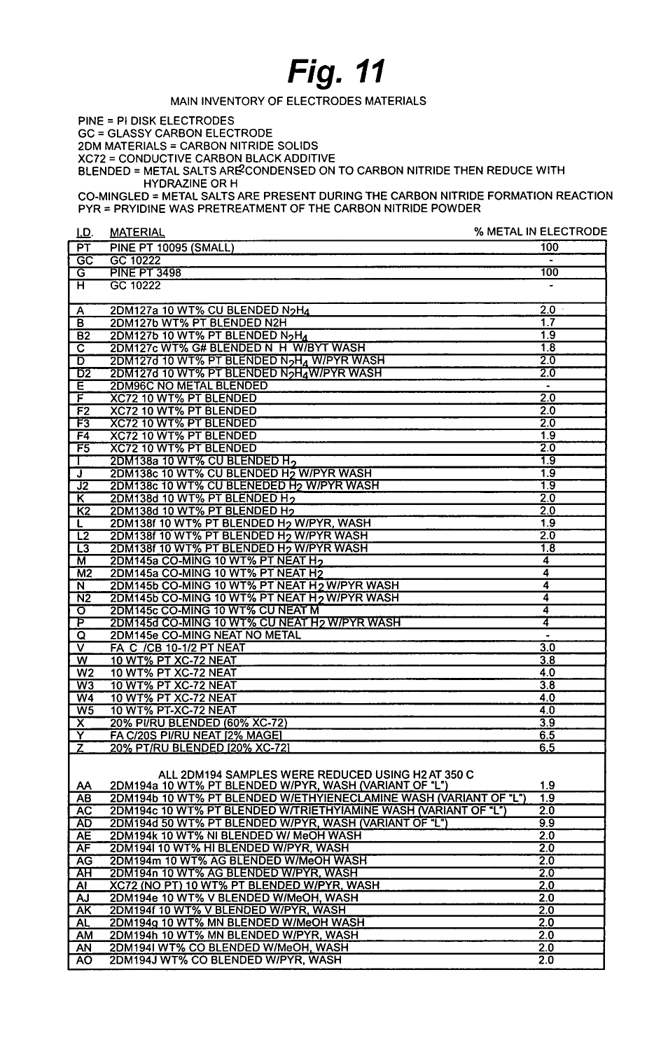

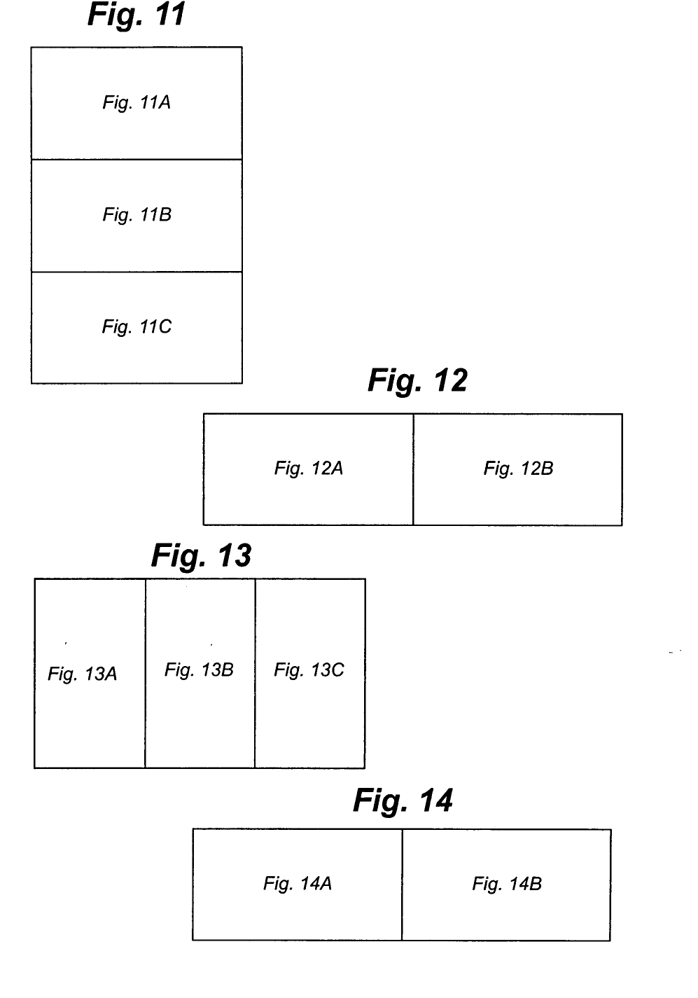

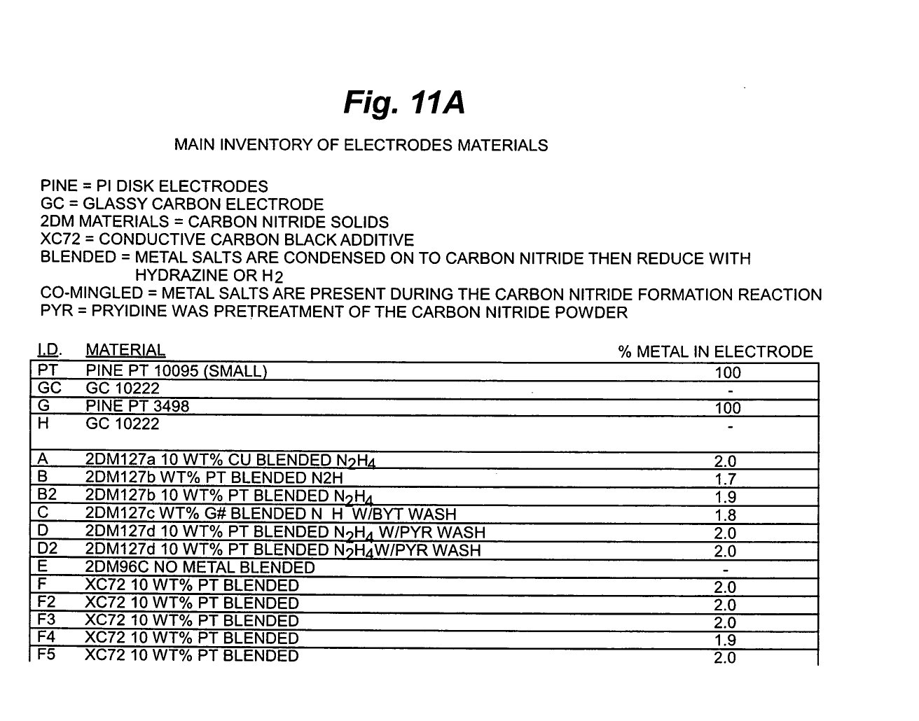

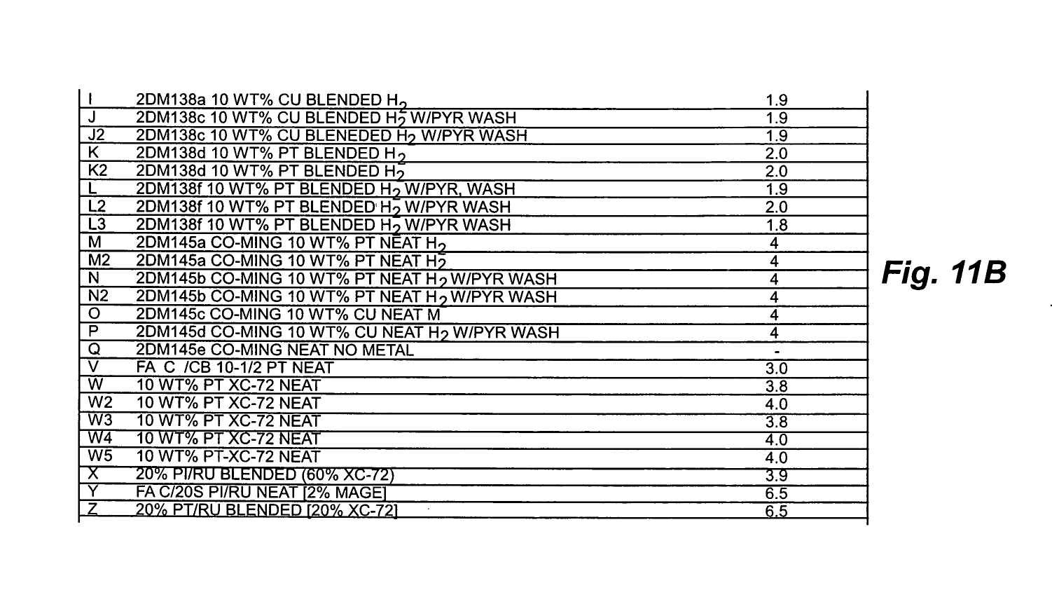

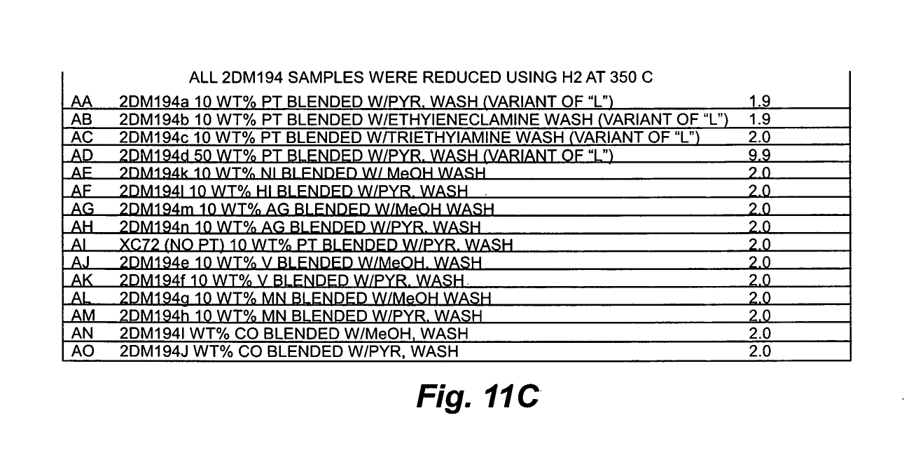

Carbon monoxide is a recognized problematic constituent of reformate hydrogen and is a byproduct of several hydrocarbon fuel oxidations processes. CO is a well-established strongly binding Lewis basic ligand for many transition metals, particularly platinum. CO passivates reactive Pt metal catalytic sites, resulting in degradation of its catalytic properties. Typically, adsorbed CO is removed from a Pt or other metal surface by sweeping to a positive potential (>+500 mV vs. SCE), which generates a CO stripping wave in the CV scan. In contrast to the Pt disk electrode standards, which show well-defined stripping waves, the Pt/C₃N₄₊ₓ samples generally displayed broader CO response waves (FIG. 9A), similar to those displayed by some of the commercial Pt on carbon control electrodes (FIG. 9B). FIG. 9 shows representative CV scans for several platinum based catalytic systems.

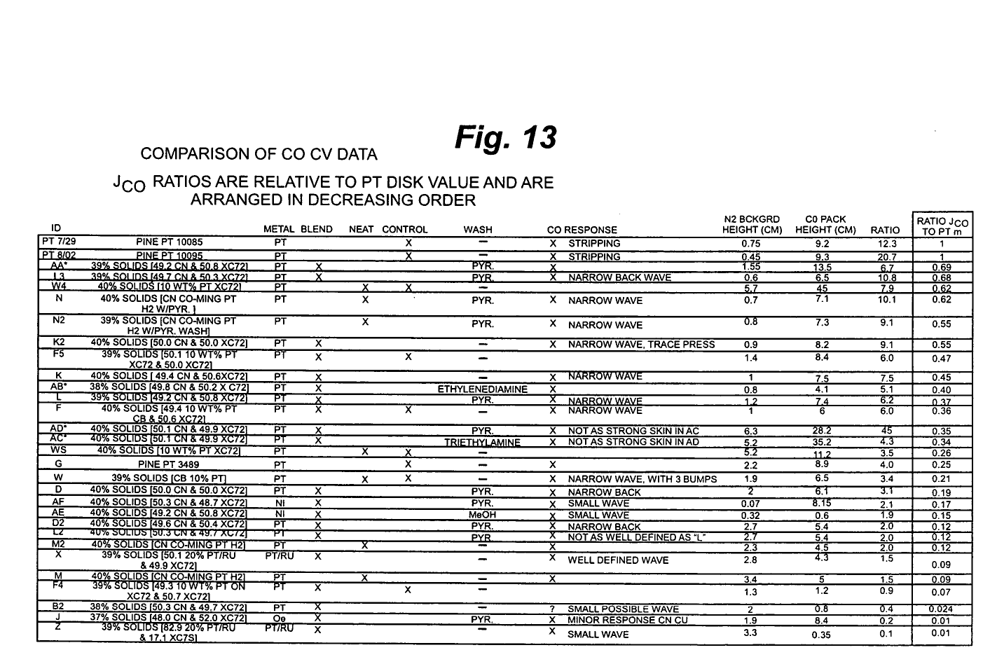

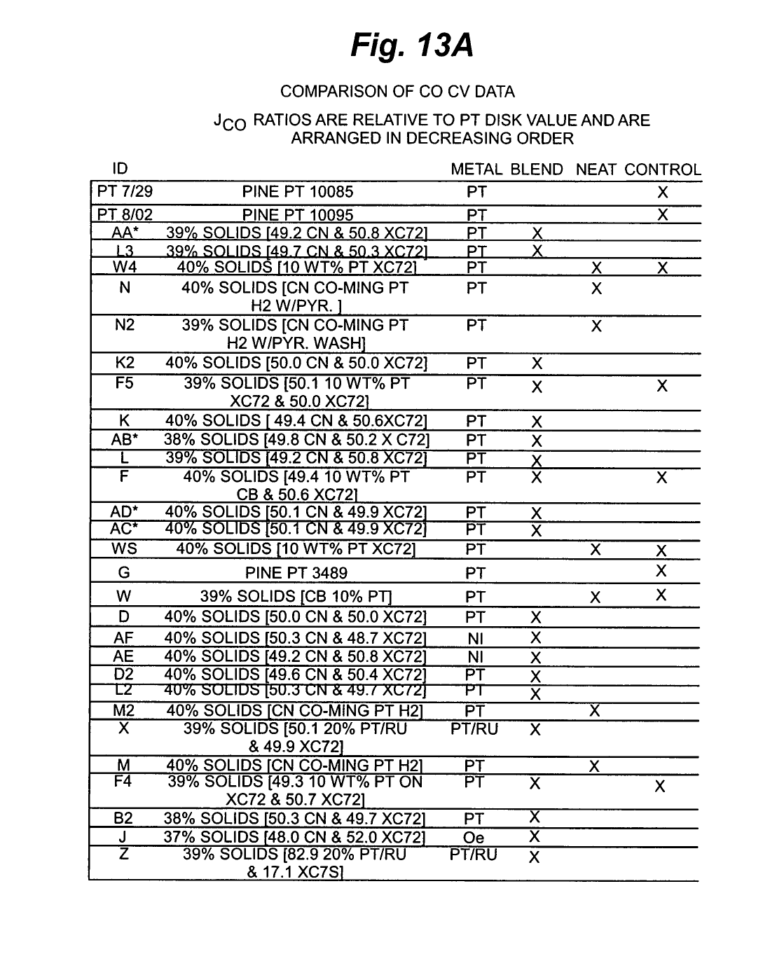

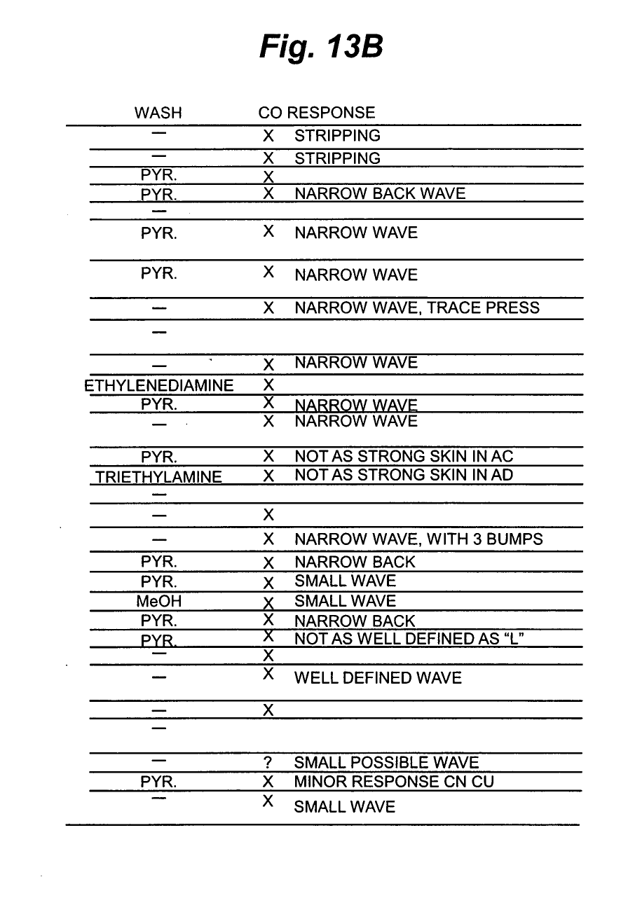

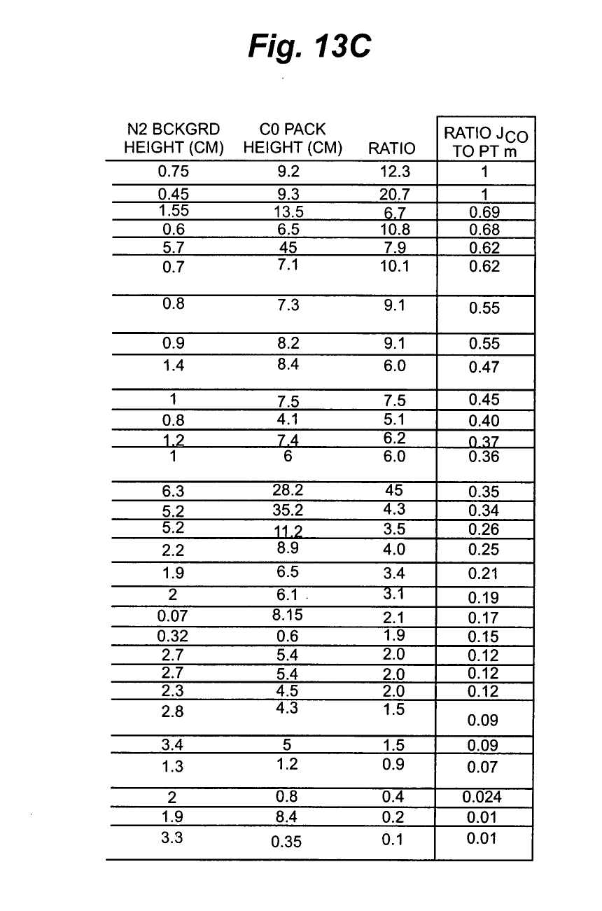

In contrast to the O₂ data, the relative current densities recorded for the observed CO peaks are lower for all carbon paste electrodes relative to the Pt disk electrode value. Notably, the pyridine treated Pt/Pt/C₃N₄₊ₓ based electrodes show values similar to those prepared from commercial Pt on carbon black. These samples had current densities in the range of 50-70% of that observed for the Pt disk electrode. The entire range of Pt samples had relative current densities from 10 to 70% relative to the Pt disk value and Ni impregnated samples showed small CO waves, corresponding to ˜15% relative current densities to that of Pt disks. Ratios of peak current densities relative to Pt disks are listed in FIG. 13. In all cases, the ratio is less than 1. This result is a bit deceiving in that the Pt disk wave yields to a stripping wave and the other systems do not. Note that the Ni value may be low due to errors in the calculated electrode area. FIG. 13 tabulates data and observations for several carbon paste electrode preparations involving CO electrochemistry. Overall, there are significant electrochemical events observed for both Pt and Ni impregnated carbon nitride materials in CO saturated solutions, relative to those observed in N₂ saturated solutions. Copper and other metal impregnated carbon nitride samples also show several observable electrochemical events in CO versus N₂ solutions, but the source of these events is still unclear.

Methanol Electrochemical Results

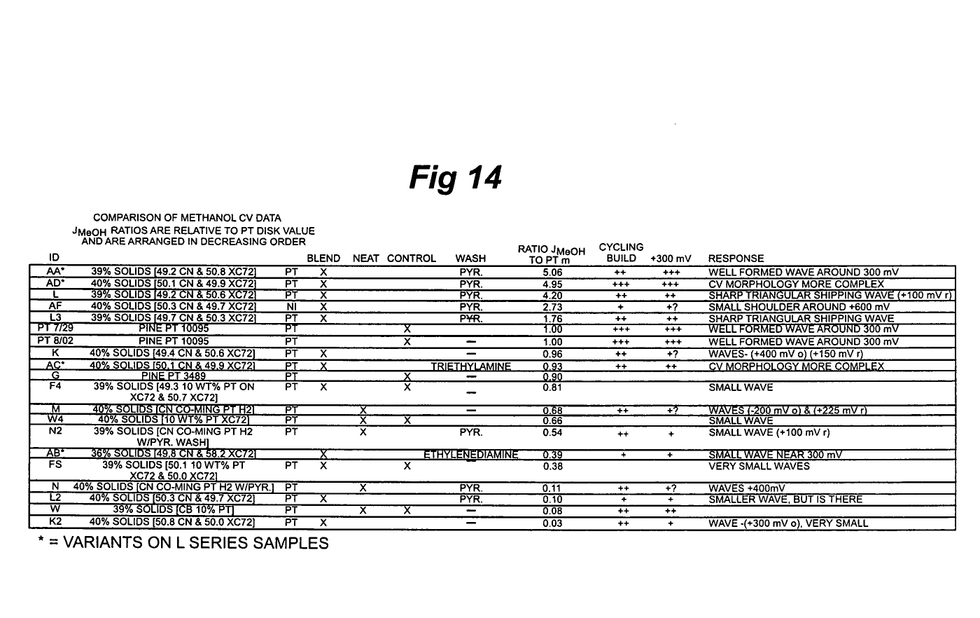

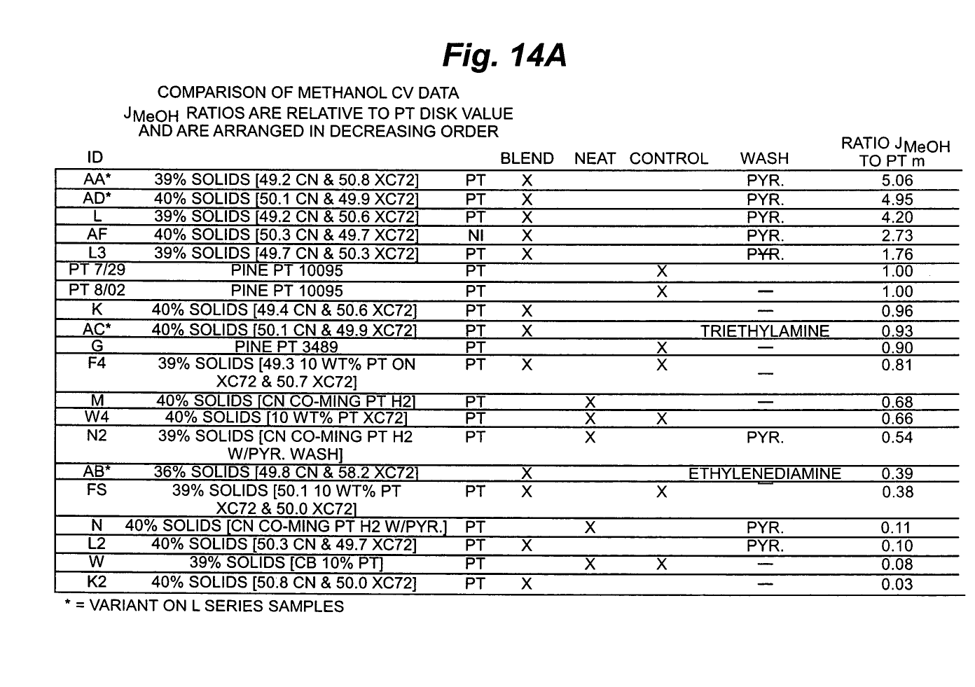

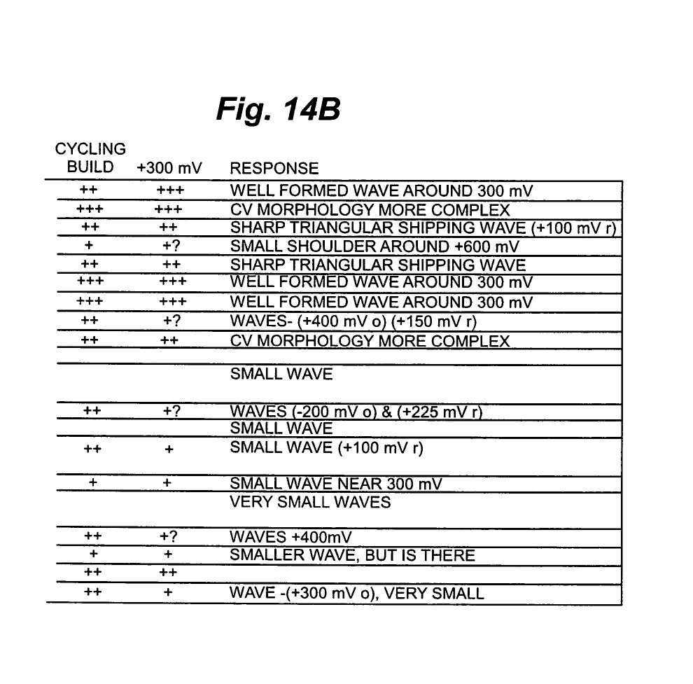

In methanol solution, the Pt disk control electrodes show distinct wave onsets around +300 mV vs. SCE. The pyridine pretreated Pt/C₃N₄₊ₓ carbon paste electrodes exhibited similar responses with consistently greater peak current densities (2-5 times greater) relative to the Pt disk value. In contrast, the commercial Pt on carbon black carbon paste electrodes showed weak or unobservable events near 300 mV, with only 90% or less current density relative to the Pt disk value. A Ni/C₃N₄₊ₓ sample showed more complex electrochemistry and well-defined peaks near 600 mV. FIG. 10 shows a CV comparison of several Pt containing samples in methanol containing electrolyte. FIG. 14 lists more extensive information on a wide range of Pt and Ni based carbon nitride and control electrode experiments. The pyridine washed Pt/C₃N₄₊ₓ samples all yield current densities several times that of a Pt disk electrode. The lone Ni electrode is also pyridine washed and also performed well.

### Summary

Initial experiments support the contention that the nitrogen-rich carbon nitride materials can be incorporated into a conducting composite system.

The in-situ generated C₃N₄₊ₓ—carbon black composite formation method is a promising strategy to produce homogeneous electrically conducting systems.

The C₃N₄₊ₓ materials are inert under acidic and neutral electrochemical environments and do not impede oxidation-reduction reactions.

The carbon nitride solids were impregnated with metal species using hydrogen reduction methods, with pyridine sample pretreatment appearing to improve metal salt adsorption, which may yield a more homogeneous distribution of metal on the surface.

Physical mixtures of the M/C₃N₄₊ₓ materials with carbon black show electrochemical activity toward O₂, CO, and methanol solutions.

In the oxygen and methanol cases, the calculated current densities of metal—carbon nitride materials comparable to or greater than those observed for commercial Pt on carbon black standards.

Because numerous modifications of this invention may be made without departing from the spirit thereof, the scope of the invention is not to be limited to the embodiments illustrated and described. Rather, the scope of the invention is to be determined by the appended claims and their equivalents.

We claim:

1. A supported catalyst comprising metalated carbon nitride.

2. The supported catalyst of claim 1, wherein the metal is selected from the group consisting of platinum, nickel, silver, cobalt, vanadium, ruthenium, iron, manganese, and copper.

3. The supported catalyst of claim 2, wherein the metal is platinum.

4. The supported catalyst of claim 1, wherein the metalated carbon nitride is metalated with two metals.

5. The supported catalyst of claim 4, wherein the metals are cobalt and iron.

6. The supported catalyst of claim 4, wherein the metals are platinum and ruthenium.

7. The supported catalyst of claim 1, wherein at least a portion of the carbon nitride is bonded to carbon cloth.

8. The supported catalyst of claim 1, further comprising carbon black.

9. The supported catalyst of claim 2, wherein the carbon black is present in an amount that is 25% to 75% by weight.

10. The supported catalyst of claim 1, wherein the carbon black is VULCAN® XC-72 carbon black.

11. A method for producing a supported catalyst comprising metalating carbon nitride.

12. The method of claim 11, wherein the wherein the metal is selected from the group consisting of platinum, nickel, silver, cobalt, vanadium, ruthenium, iron, manganese, and copper.

13. The method of claim 11, wherein the method further comprises metalating the carbon nitride in the presence of methanol.

14. The method of claim 11, wherein the method further comprises treating the carbon nitride with a strong organic base prior to metalating the carbon nitride.

15. The method of claim 14, wherein the strong organic base is pyridine.

16. The method of claim 11, further comprising modifying one or more functional groups on the carbon nitride prior to metalating.

17. The method of claim 16, wherein the one or more functional groups on the carbon nitride is modified with an organochloride.

18. A fuel cell comprising a metalated carbon nitride catalyst.

19. The fuel cell of claim 18, wherein the carbon nitride catalyst is located on at least one electrode.

20. The fuel cell of claim 19, wherein the at least one electrode is coated with a perfluorosulfonic acid polymer.
